(19) United States
(12) Patent Application Publication
(10) Pub. No.: US 2011/0274127 A1
(43) Pub. Date: Nov. 10, 2011

(54) PULSE LASER, OPTICAL FREQUENCY STABILIZED LASER, MEASUREMENT METHOD, AND MEASUREMENT APPARATUS

(75) Inventors: Shin MASUDA, Miyagi (JP); Hajime INABA, Ibaraki (JP)

(73) Assignees: National Institute of Advanced Industrial Science and Technology, Tokyo (JP); ADVANTEST CORPORATION, Tokyo (JP)

(21) Appl. No.: 13/018,114

(22) Filed: Jan. 31, 2011

(30) Foreign Application Priority Data
Mar. 1, 2010 (JP) 2010-044588

(51) Int. Cl. H01S 3/10; H01S 3/00

(52) U.S. Cl. 372/25; 372/38.01

(57) ABSTRACT

The object is to measure the carrier envelope offset frequency of a mode-locked laser. Provided is a pulse laser that measures a carrier envelope offset frequency of a mode-locked laser, pulse laser comprising a mode-locked laser that generates an optical pulse; a band expanding section that expands an oscillated frequency range of the mode-locked laser; a harmonic generating section that generates a harmonic component of the mode-locked laser; a light transmitting section that inputs light to the harmonic generating section without changing relative timings of a predetermined frequency component of the mode-locked laser output from the band expanding section and a frequency component that is at least double the predetermined frequency component; a detecting section that detects a beat signal of the harmonic component and the component passed through the harmonic generating section by the mode-locked laser; and a calculating section that calculates a carrier envelope offset frequency and a repeating frequency based on the beat signal.

### BACKGROUND

1. Technical Field

The present invention relates to a pulse laser, an optical-frequency-stabilized laser, a measurement apparatus, and a measurement method.

2. Related Art

One technique for accurately measuring optical frequency involves using an optical frequency comb generated from a femtosecond laser, as shown in Patent Document 1 and Non-Patent Documents 1 to 4, for example.
Patent Document 1: Japanese Patent Application Publication No. 2004-340690
Non-Patent Document 1: Brian R. Washburn, et al., “Phase-locked, erbium-fiber-laser-based frequency comb in the near infrared”, Optics Letters, USA, February 2004, Vol. 29, No. 3, pp. 250-252
Non-Patent Document 2: Holger Hundertmark, et al., “Phase-locked carrier-envelope-offset frequency at 1560 nm”, Optics Express, USA, March 2004, Vol. 12, No. 5, pp. 770-775
Non-Patent Document 3: T. R. Schibli, et al., “Frequency metrology with a turnkey all-fiber system”, Optics Letters, USA, November 2004, Vol. 29, No. 21, pp. 2467-2469
Non-Patent Document 4: Hajime Inaba, et al., “Long-term measurement of optical frequencies using a simple, robust and low-noise fiber based frequency comb”, Optics Express, USA, June 2006, Vol. 14, No. 12, pp. 5223-5231

An ultrashort pulse having a pulse width on the order of femtoseconds and a pulse interval of 1/fᵣₑₚ has an output in which pulses are lined up at uniform intervals on the frequency axis in the shape of a comb, which is where the term “optical frequency comb” comes from. An n-th spectrum forming this optical frequency comb can be expressed on the frequency axis using the expression below.

f(n)=n·fᵣₑₚ+f_{CEO} Expression 1

Here, f_{CEO} represents an offset of the optical frequency comb on the frequency axis, and is also known as a carrier envelope offset. Accordingly, if f_{CEO} and the repeating frequency fᵣₑₚ of the optical pulses are known, the optical frequency comb can be used as a scale on the optical frequency axis to perform an optical frequency measurement. In order to measure f_{CEO}, a complicated operation and adjustment by a large measurement apparatus are required.

### SUMMARY

Therefore, it is an object of an aspect of the innovations herein to provide a pulse laser, an optical-frequency-stabilized laser, a measurement apparatus, and a measurement method, which are capable of overcoming the above drawbacks accompanying the related art. The above and other objects can be achieved by combinations described in the claims. According to a first aspect of the present invention, provided is a pulse laser that measures a carrier envelope offset frequency of a mode-locked laser, pulse laser comprising a mode-locked laser that generates an optical pulse; a band expanding section that expands an oscillated frequency range of the mode-locked laser; a harmonic generating section that generates a harmonic component of the mode-locked laser; a light transmitting section that inputs light to the harmonic generating section without changing relative timings of a predetermined frequency component of the mode-locked laser output from the band expanding section and a frequency component that is at least double the predetermined frequency component; a detecting section that detects a beat signal of the harmonic component and the component passed through the harmonic generating section by the mode-locked laser; and a calculating section that calculates a carrier envelope offset frequency and a repeating frequency based on the beat signal.

The summary clause does not necessarily describe all necessary features of the embodiments of the present invention. The present invention may also be a sub-combination of the features described above.

### BRIEF DESCRIPTION OF THE DRAWINGS

FIG. 1 shows an exemplary configuration of a pulse laser 100 according to an embodiment of the present invention.

FIG. 2 shows exemplary frequency spectra in portions of the pulse laser 100 according to the present embodiment.

FIG. 3 shows an exemplary configuration of an optical system for focusing optical pulses of the pulse laser 100 according to the present embodiment.

FIG. 4 shows a process flow of the pulse laser 100 according to the present embodiment.

FIG. 5 shows an exemplary modification of the pulse laser 100 according to the present embodiment.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

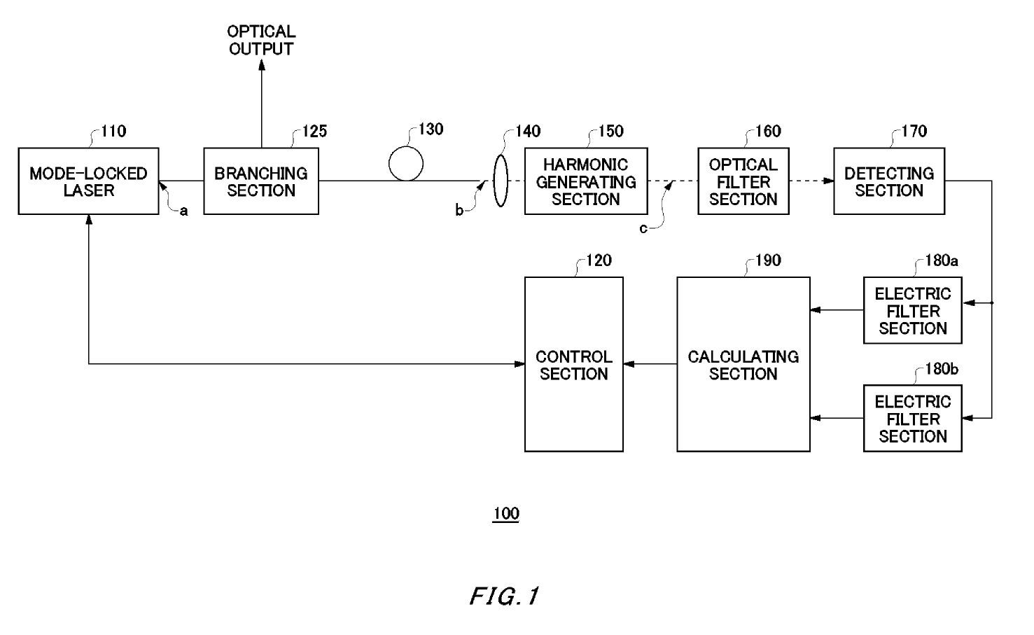

FIG. 1 shows an exemplary configuration of a pulse laser 100 according to an embodiment of the present invention. The pulse laser 100 measures a carrier envelope offset frequency and a repeating frequency of an ultrashort pulse. The pulse laser 100 includes a mode-locked laser 110, a control section 120, a branching section 125, a band expanding section 130, a light transmitting section 140, a harmonic generating section 150, an optical filter section 160, a detecting section 170, an electric filter section 180, and a calculating section 190.

The mode-locked laser 110 generates optical pulses. The mode-locked laser 110 may output short-pulse light with a pulse width in an order of picoseconds by generating a prescribed phase relationship between a plurality of modes by which a laser is oscillated. The mode-locked laser 110 may be an active mode-locked laser that actively locks the phase between the modes using an optical modulator in a resonator, or may be a passive mode-locked laser in which the phase between the modes is passively locked by the nonlinearity of optical components in the resonator.

The control section 120 controls the mode-locked laser 110. The control section 120 may control the starting and stopping of the oscillation of the mode-locked laser 110 by transmitting a control signal to the mode-locked laser 110. The control section 120 may control the repeating frequency and the oscillation frequency of the mode-locked laser 110.

For example, the control section 120 may control the carrier envelope offset frequency of the mode-locked laser 110 by comparing the carrier envelope offset frequency measured by the pulse laser 100 to a reference frequency. As an example, the control section 120 may control the carrier envelope offset frequency of the mode-locked laser 110 by adjusting the pump optical intensity of the mode-locked laser 110 based on the measurement results of the carrier envelope offset frequency of the mode-locked laser 110.

The control section 120 may control the repeating frequency of the mode-locked laser 110 by comparing the repeating frequency measured by the pulse laser 100 to a reference frequency. As an example, the control section 120 may control the repeating frequency of the mode-locked laser 110 by adjusting the resonator length of the mode-locked laser 110 based on the measurement results of the repeating frequency of the mode-locked laser 110. The control section 120 supplies the branching section 125 with an optical pulse in which the repeating frequency and the oscillation frequency are stabilized.

The branching section 125 branches the optical pulse output from the mode-locked laser 110. The branching section 125 may be an optical fiber coupler that splits input light into two branches. One of these branches becomes optical output of the pulse laser 100 and the other is supplied to the band expanding section 130 as an optical pulse. Instead, the branching section 125 may be an optical branching device such as an optical prism or a wave guide that splits input light into two branches.

The band expanding section 130 expands the oscillated frequency range of the mode-locked laser 110. The band expanding section 130 may be a highly nonlinear fiber (HNLF). For example, the band expanding section 130 may be quartz optical fiber to which GeO₂ or the like is added, or may be photonic crystal fiber having holes formed periodically in the cross section thereof.

The band expanding section 130 may generate an ultrashort pulse on an order of femtoseconds in the time domain for the optical pulse output from the mode-locked laser 110, and this corresponds to generating an octave optical comb whose oscillation frequency band is expanded by one or more octaves in the frequency domain. Generation of a broadband octave optical comb by inputting short-pulse laser light into highly nonlinear optical fiber is widely known as generating super continuum (SC) light, and therefore the reason why the oscillated frequency range expands is not explained.

The light transmitting section 140 inputs light to the harmonic generating section 150, without changing the relative timings of a predetermined frequency component of the mode-locked laser 110 output from the band expanding section 130 and a frequency component that is at least double this predetermined frequency component. The light transmitting section 140 receives the octave optical comb output from the band expanding section 130 and transmits this octave optical comb to the harmonic generating section 150. The frequency dispersion of the light transmitting section 140 is such that the predetermined frequency component in the oscillation band of the optical pulse and the frequency component that is double this predetermined frequency component are input to the harmonic generating section 150 at approximately the same time.

The light transmitting section 140 may use a converging lens to input the optical pulse output from the band expanding section 130 to the harmonic generating section 150 as focused light. The light transmitting section 140 may be an optical lens or optical fiber. Instead, the light transmitting section 140 may be a wave guide or a combination of an optical lens and a wave guide. Since the light transmitting section 140 transmits a broadband optical pulse, the light transmitting section 140 may be an optical fiber, a wave guide, and/or an optical component with low frequency dispersion.

The harmonic generating section 150 generates a harmonic component of the mode-locked laser 110. The harmonic generating section 150 may be a nonlinear optical component, and may generate a second order harmonic of the octave optical comb transmitted by the light transmitting section 140. For example, the harmonic generating section 150 may be a waveform converter in which periodic polarization inversion is performed using materials such as lithium tantalite or LiNbO₃ (lithium niobate).

Instead, the harmonic generating section 150 may be a nonlinear crystal made of ADP (monoammonium phosphate), KDP (potassium dihydrogen phosphate), LiNbO₃, BBO (beta barium borate), Se (Selenium), Te (tellurium), or the like. Generation of a second order harmonic using such a nonlinear optical element is widely known, and the fundamentals of this generation are therefore not explained. The harmonic generating section 150 propagates the second order harmonic of the generated octave optical comb to the detecting section 170 via the optical filter section 160.

The optical filter section 160 passes a frequency component within a predetermined frequency range in the optical pulse detected by the detecting section 170. The optical filter section 160 may be a band-pass filter that passes a specific frequency, or may be a high-pass filter and/or low-pass filter. The optical filter section 160 passes the specific frequency component of the octave optical comb passed by the harmonic generating section 150 and the second order harmonic generated by the harmonic generating section 150, and propagates this specific frequency component to the detecting section 170.

The detecting section 170 detects the component passed through the harmonic generating section 150 by the mode-locked laser 110 and a beat signal of the harmonic component. The detecting section 170 may be a photodetector that converts received light into an electric signal. The detecting section 170 may be a photodetector having a light receiving section using semiconductor material such as Si, GaAs, or InGaAs.

The detecting section 170 may detect the repeating frequency of the received octave optical comb, which is the repeating frequency of the optical pulse of the mode-locked laser 110, along with the beat signal. The detecting section 170 transmits the electric signal resulting from the conversion to the calculating section 190 via the electric filter section 180.

The electric filter section 180 passes frequency components in a frequency range corresponding to the carrier envelope offset in the beat signal detected by the detecting section 170. The electric filter section 180 may be a low-pass filter, a high-pass filter, or a band-pass filter, or may be a combination of these filters. A plurality of the electric filter sections 180 may be included in the pulse laser 100 according to the frequencies to be measured. The pulse laser 100 may further include a second electric filter section that passes a frequency component in a frequency range corresponding to the repeating frequency.

The calculating section 190 calculates the carrier envelope offset frequency based on the beat signal. If the detecting section 170 detects the repeating frequency of the optical pulse of the mode-locked laser 110, the calculating section 190 may calculate the repeating frequency. The calculating section 190 transmits the calculated frequencies to the control section 120.

The pulse laser 100 having the configuration described above generates the octave optical comb of the optical pulse emitted by the mode-locked laser 110 and the second order harmonic of the octave optical comb, and detects the carrier envelope offset frequency. The pulse laser 100 may measure the frequency of an unknown light source by combining the optical output of an octave optical comb whose frequency is known with the optical output of a light source with an unknown frequency and measuring the resulting beat signal.

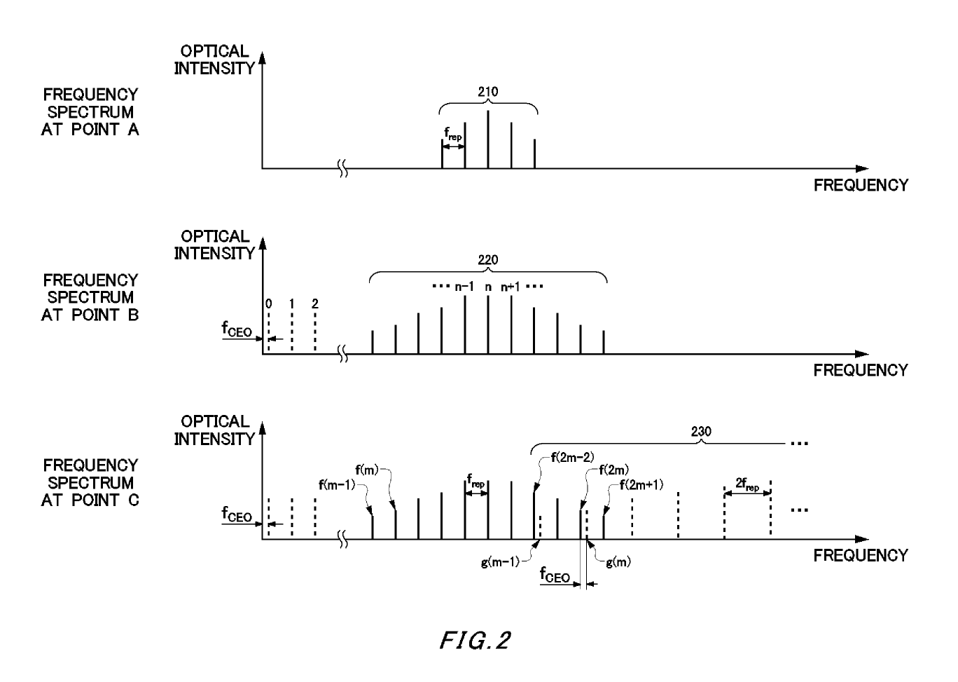

FIG. 2 shows exemplary frequency spectra in portions of the pulse laser 100 according to the present embodiment. The frequency spectrum at point A is the spectrum of the optical pulse output from the mode-locked laser 110. When the mode-locked laser 110 outputs an optical pulse with a pulse width on the order of several picoseconds, the oscillated frequency range 210 of the optical pulse is less than one octave due to the Fourier transform limitation. The mode-locked laser 110 outputs the optical pulse with a repeating frequency fᵣₑₚ, and therefore the oscillated frequency range 210 is an optical comb with intervals of fᵣₑₚ.

The frequency spectrum at point B shows the octave optical comb 220 output from the band expanding section 130. Since the band expanding section 130 expands the oscillated frequency of the oscillated frequency range 210 output by the mode-locked laser 110 to be greater than or equal to one octave, the frequency distribution of the octave optical comb 220 can be expressed as shown in Expression 1. Here, the offset frequency between the octave optical comb 220 and the zero-point on the frequency axis is referred to as the carrier envelope offset (f_{CEO}).

The present embodiment describes an example in which the mode-locked laser 110 outputs optical pulses with a pulse width of several ps, i.e. optical pulses in which the oscillated frequency range is less than one octave, but instead, the mode-locked laser 110 may output optical pulses having an oscillated frequency greater than or equal to one octave. In this case, the pulse laser 100 need not include the band expanding section 130.

The frequency spectrum at point C shows the second order harmonic 230 of the octave optical comb generated by the harmonic generating section 150. The band expanding section 130 generates an optical pulse whose oscillated frequency is greater than or equal to one octave, and therefore a portion on the high-frequency side of the octave optical comb 220 overlaps with a portion on the low-frequency side of the second order harmonic 230. The detecting section 170 detects the beat signal in this overlapping region. The harmonic generating section 150 generates the second order harmonic 230 of the octave optical comb 220, and therefore each component in the spectrum of the second order harmonic 230 can be expressed as shown in Expression 2.

g(n)=2·f(n)=2n·fᵣₑₚ+2f_{CEO} Expression 2

The detecting section 170 detects the difference between Expression 1 and Expression 2 as the beat signal, and this corresponds to measuring f_{CEO} as the difference between f(2n) and g(n). The band expanding section 130 generates the octave optical comb 220 from f(m−1) to f(2m+1) and the harmonic generating section 150 generates the second order harmonic 230 from g(m−1) to g(2m+1). The detecting section 170 can measure the beat signal in the range where the octave optical comb 220 and the second order harmonic 230 overlap. In other words, the detecting section 170 can measure f_{CEO} as the difference between f(2m) and g(m).

The band expanding section 130 generates the optical comb to be greater than or equal to one octave, and therefore f_{CEO} can also be measured as the difference between f(2m−2) and g(m−1), and the signal strengths of these beat signals are superimposed on each other. In other words, the detecting section 170 can superimpose more beat signals when the oscillated range of the octave optical comb is wider, thereby increasing the optical intensity to be detected.

The detecting section 170 receives an optical spectrum in a range where the octave optical comb 220 and the second order harmonic 230 do not overlap. However, the spectrum in this range does not generate a beat signal that can be measured as f_{CEO}, and therefore the S/N ratio and dynamic range become worse. Accordingly, the detecting section 170 can improve the S/N ratio and the dynamic range by using the optical filter section 160 to eliminate the optical spectrum in the range where the octave optical comb 220 and the second order harmonic 230 do not overlap.

The detecting section 170 detects beat signals other than f_{CEO}. For example, the detecting section 170 may detect beat signals with frequencies of k×fᵣₑₚ, where k=1, 2, 3, etc., using each frequency component of the optical comb. The detecting section 170 detects the beat signal with a frequency fᵣₑₚ−f_{CEO} using f(2m−1) and g(m−1) together with f(2m+1) and g(m). The electric filter section 180 may pass to the calculating section 190 the beat signal corresponding to the frequency to be measured from among the beat signals detected by the detecting section 170.

In the configuration described above, the pulse laser 100 detects the beat signal for the octave optical comb 220 and the second order harmonic 230 of the octave optical comb, and measures the carrier envelope offset and the repeating frequency of the octave optical comb. However, the detecting section 170 cannot detect a beat signal if ultrashort pulse component withs a pulse width on the order of femtoseconds, such as f(2m) and g(m), are not detected at the same time.

Here, since f(2m) and g(m) have almost the same oscillated frequency, even if there is an optical element that has significant frequency dispersion between the harmonic generating section 150 and the detecting section 170, the detecting section 170 can detect f(2m) and g(m) at almost the same time if f(2m) and g(m) are output from the harmonic generating section 150 at the same time. Accordingly, the harmonic generating section 150 is required to output f(2m) and g(m) at the same timing.

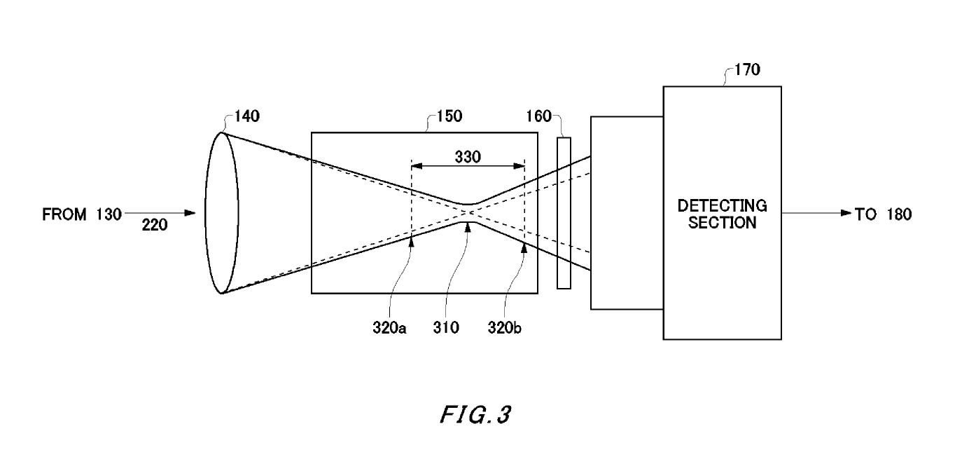

The harmonic generating section 150 generates g(m) as the second order harmonic of f(m), and therefore, in order for the harmonic generating section 150 to output f(2m) and g(m) at the same timing, f(2m) and f(m) must be input to the harmonic generating section 150 at the same timing. In other words, a beat signal cannot be detected unless the pulse laser 100 focuses f(m) and f(2m), which are beams of light differing in frequency by one octave, at the harmonic generating section 150 at the same time, with precision on the order of femtoseconds. The pulse laser 100 can use the configuration shown in FIG. 3 to realize an optical system for detecting a beat signal.

FIG. 3 shows an exemplary configuration of an optical system for focusing optical pulses of the pulse laser 100 according to the present embodiment. FIG. 3 shows an exemplary configuration of the optical system of FIG. 1 from the light transmitting section 140 to the detecting section 170. The light transmitting section 140 receives the optical pulse of the octave optical comb 220 output from the band expanding section 130. At this point, f(m) and f(2m) may be input to the light transmitting section 140 at the same time.

In order to effectively use the waveform conversion efficiency of the harmonic generating section 150, the light transmitting section 140 may use a lens to focus the optical pulse in the harmonic generating section 150. If the harmonic generating section 150 uses a nonlinear optical crystal, for example, the conversion power Pₛₕ can be obtained using Expression 3.

$${P}_{sh} = \frac{16 {π}^{2} {d}_{eff}^{2} {lP}_{in}^{2}}{{n}_{f} {n}_{sh} c {ɛ}_{0} {λ}^{3}} h ( B , ξ ) \qquad Expression 3$$

Here, d_{eff} represents a nonlinear optical constant, l represents the crystal length, Pᵢₙ represents the incident light intensity, h(B, ξ) represents a confocal parameter, n_{f} represents the incident refractive index, nₛₕ represents a second harmonic refractive index, ε₀ represents vacuum permittivity, and λ represents the incident light waveform. In this way, the conversion power of the harmonic generating section 150 is greatly affected by the confocal parameter of the incident light.

In FIG. 3, the light transmitting section 140 minimizes the beam diameter at the position of the beam waist 310 in the harmonic generating section 150. Furthermore, the light transmitting section 140 focuses the beam to have double the beam area at the focusing end 320a and the focusing end 320b than at the beam waist 310, for example. In the focal distance 330, which is the range between the focusing end 320a and the focusing end 320b, the light transmitting section 140 increases the optical intensity accuracy so that the harmonic generating section 150 efficiently generates the second order harmonic.

As an example, with “b” being the focal distance 330 and ξ=L/b=2.84, h(B, ξ) is known to have an optimal value of 1.068. For example, in a converging confocal optical system, i.e. when B=0, with a crystal length of l=30 mm, ξ=L/b=2.84 and b=10.6 mm. In this case, the optimal beam radius is estimated to be 51 μm.

The mode-locked laser 110 may output light between the visible region and near infrared light, having a wavelength on the order of several micrometers or less. The theoretical resolution unit of an ideal lens is the wavelength of light input thereto, and therefore the light transmitting section 140 can contract the beam radius to 51 μm. By arranging a single lens near the output portion of the band expanding section 130, the light transmitting section 140 can form an optical system that has a length of several centimeters from the output end of the band expanding section 130 to the output end of the harmonic generating section 150.

The light transmitting section 140 may focus the optical pulse output from the band expanding section 130 in the detecting section 170, via the harmonic generating section 150. The harmonic generating section 150 converts the optical pulse focused by the light transmitting section 140 into a waveform with an efficiency that is theoretically based on Expression 3, and passes the optical pulse with the remaining intensity as-is. The light transmitting section 140 minimizes the beam radius of the octave optical comb 220 at the beam waist 310, and therefore the passed optical pulse is output from the harmonic generating section 150 while the beam radius thereof widens almost symmetrically across the beam waist 310.

The detecting section 170 can receive the octave optical comb 220 passed through the harmonic generating section 150, by arranging a light receiving section near the output end of the harmonic generating section 150. By decreasing the surface area of the light receiving section, the region detectable by the detecting section 170 can be increased on the high-frequency side. Accordingly, the detecting section 170 preferably includes a light receiving section that corresponds to the repeating frequency of the mode-locked laser 110. In this case, the diameter of the light receiving section may be approximately 1 mm.

The band expanding section 130 may be highly nonlinear fiber or photonic crystal fiber, and therefore the diameter of the output end is no greater than tens of μm. Accordingly, when the light transmitting section 140 is arranged near the output portion of the band expanding section 130, the diameter of the optical pulse input to the light transmitting section 140 can be kept below 1 mm. Accordingly, by arranging the detecting section 170 such that distance between the detecting section 170 and the output portion of the harmonic generating section 150 is equal to the distance between the light transmitting section 140 and the harmonic generating section 150, the octave optical comb 220 passed by the harmonic generating section 150 can be focused in the range of a light receiving section with a diameter of approximately 1 mm.

In other words, the optical pulse can be focused in the light receiving section, which has a limited area, of the detecting section 170 by decreasing the distance from the output portion of the band expanding section 130 to the light transmitting section 140, the distance from the light transmitting section 140 to the harmonic generating section 150, and the distance from the output end of the harmonic generating section 150 to the detecting section 170. Accordingly, the pulse laser 100 can set the distance from the band expanding section 130 to the detecting section 170 to be several cm.

The light transmitting section 140 may focus the optical pulse output from the band expanding section 130 in the harmonic generating section 150, and the detecting section 170 may directly receive the optical pulse output from the harmonic generating section 150 without having this optical pulse pass through optical fiber. The harmonic generating section 150 converts the waveform optical pulse focused in the range of the focal distance 330 and outputs the result of this conversion. In this case, the harmonic generating section 150 generates the second order harmonic from the range of the focal distance 330, and therefore the optical pulse of the second order harmonic output from the harmonic generating section 150 is spatially wider than the optical pulse passed by the harmonic generating section 150.

In this case, the detecting section 170 can focus the optical pulse of the second order harmonic output from the harmonic generating section 150 in the range of the light receiving section with a diameter of approximately 1 mm by arranging the detecting section 170 closer to the output end of the harmonic generating section 150. Accordingly, an optical component such as a converging lens or optical fiber need not be interposed between the detecting section 170 and the harmonic generating section 150.

The light transmitting section 140 may adjust the position of the focal distance 330, which focuses the octave optical comb 220, in the region within the harmonic generating section 150 where the wavelength conversion efficiency is at least a prescribed reference amount, in a manner to enable the light receiving section of the detecting section 170 to receive the optical pulse of the second order harmonic output by the harmonic generating section 150 and the optical pulse passed by the harmonic generating section 150. For example, if the focal distance 330 is focused closer to the detecting section 170 in the harmonic generating section 150, the light transmitting section 140 can decrease the surface area necessary for the detecting section 170 to receive light.

When the sensitivity of the detecting section 170 is sufficient to receive both the optical pulse passed by the harmonic generating section 150 and the second order harmonic output by the harmonic generating section 150, both beam radii need not be contained within the light receiving surface. In this case, the detecting section 170 may be arranged at a position to allow for easy handling. Furthermore, the optical filter section 160 may use a component with a thickness of several mm, and therefore may be arranged in the space between the harmonic generating section 150 and the detecting section 170.

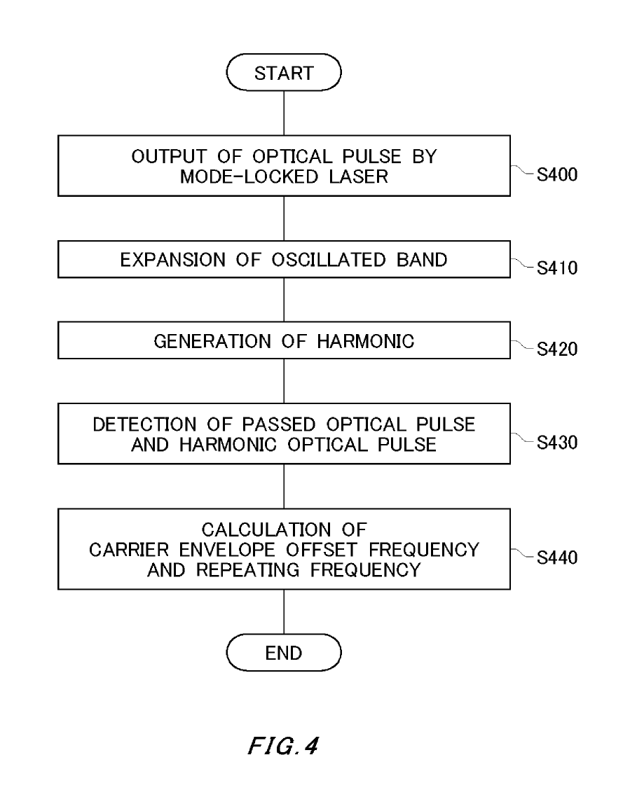

FIG. 4 shows a process flow of the pulse laser 100 according to the present embodiment. The mode-locked laser 110 outputs an optical pulse with a prescribed repeating frequency (S400). The mode-locked laser 110 may output the optical pulse in response to a control signal received from the control section 120.

The mode-locked laser 110 includes a single feedback control mechanism, and may output the optical pulse with a stable repeating frequency and/or a stable oscillated frequency band. Instead, the mode-locked laser 110 may output a stabilized optical pulse according to feedback control of the control section 120, based on the repeating frequency and/or carrier envelope offset frequency measured by the pulse laser 100.

The band expanding section 130 expands the oscillated frequency band of the optical pulse output by the mode-locked laser 110 (S410). The mode-locked laser 110 may output the optical pulse through optical fiber or may emit the optical pulse into open space. The band expanding section 130 may receive the optical pulse by being connected to the fiber output end of the mode-locked laser 110 via a connector or by fusing, or may receive the optical pulse output by the mode-locked laser 110 through an optical element such as a lens.

The light transmitting section 140 focuses the octave optical comb output from the band expanding section 130 in the harmonic generating section 150, and generates the second order harmonic (S420). The light transmitting section 140 may be a lens or may be a combination of optical fiber and a lens. If the optical fiber used is long enough that the dispersion therein cannot be ignored, the light transmitting section 140 may include an optical device that compensates for this dispersion.

The detecting section 170 receives, at the same time, the optical pulse passed by the harmonic generating section 150 and the optical pulse of the second order harmonic generated by the harmonic generating section 150 (S430). The detecting section 170 detects the beat signals generated by the two optical pulses. The detecting section 170 detects the beat signals corresponding respectively to the repeating frequency and the carrier envelope offset frequency. The electric filter section 180 may be a filter with a pass band set for the frequency to be detected, and passes a prescribed beat signal from among the beat signals detected by the detecting section 170.

The calculating section 190 receives the passed beat signal and calculates a prescribed frequency (S440). For example, the calculating section 190 may calculate the repeating frequency and/or the carrier envelope offset frequency. With the process flow described above, the pulse laser 100 may measure the repeating frequency and/or the carrier envelope offset frequency. As a result, the pulse laser 100 can output, as the optical output from the branching section 125, an optical pulse with a known repeating frequency and/or carrier envelope offset frequency.

According to the embodiments described above, the pulse laser 100 focuses the optical pulse output by the band expanding section 130 in the harmonic generating section 150 to efficiently generate the second order harmonic. Furthermore, the pulse laser 100 can receive both the optical pulse passed by the harmonic generating section 150 and the second order harmonic output by the harmonic generating section 150 in the detecting section 170 at the same time. The pulse laser 100 may include the light transmitting section 140 configured as a single lens, and can set the optical distance from the band expanding section 130 to the detecting section 170 to be several cm.

Even if the focusing results in the optimal beam diameter for the harmonic generating section 150 to achieve the optimal conversion efficiency, the octave optical comb and the second order harmonic thereof can be focused within the range of the light receiving surface of the detecting section 170 having an area of approximately 1 mm. In other words, by using the same lens as the converging lens that can achieve focal parameters for optimal efficiency of the harmonic generating section 150 and the lens that focuses in the detecting section 170, the pulse laser 100 can greatly shorten the optical path and decrease the size of the components in the optical system.

As a result, the pulse laser 100 can input the optical pulses to the harmonic generating section 150 with almost no change in the relative timings of the frequency components of the oscillated region of the octave optical comb output from the band expanding section 130. For example, single mode fiber used in optical transmission has a dispersion of 16 ps/nm/km, and therefore even when two light beams with wavelengths of 1 μm and 2 μm, differing by one octave frequency, are input to optical fiber at the same time, a transmission time difference of 16 ps occurs for a transmission distance of 1 m.

The optical system of the pulse laser 100 does not include a device having such high dispersion for femtosecond optical pulses, and therefore the optical pulses of the octave optical comb and the second order harmonic can be focused on the light receiving surface of the detecting section 170 with almost no difference in timing. Accordingly, the pulse laser 100 need not include an optical element for adjusting the light reception timing arranged in the optical path. In other words, since the pulse laser 100 separates the octave optical comb and the second order harmonic into individual optical paths, a large and complicated optical system for adjusting the light reception timing becomes unnecessary.

The pulse laser 100 may include the light transmitting section 140, the harmonic generating section 150, the optical filter section 160, and the detecting section 170 in the same optical path. With this configuration, the light transmitting section 140, the harmonic generating section 150, the optical filter section 160, and the detecting section 170 can be loaded and integrated on a single substrate, and therefore the pulse laser 100 can be used to manufacture a small and durable carrier envelope offset frequency detection module. As a result, the pulse laser 100 can be suitably used in a changing environment, such as during vibration or changes in temperature, and can operate for long periods of time while remaining compact.

Furthermore, the pulse laser 100 receives the optical pulses with a single detecting section 170, converts the optical pulses to electric signals, and the branches the electric signals to a circuit for detecting the carrier envelope offset frequency and the repeating frequency. As a result, the pulse laser 100 uses a single optical brancher, photodetector, and the like for measuring two frequencies, thereby decreasing the length of the optical path and decreasing the number of optical elements.

In the embodiments described above, the band expanding section 130 expands the oscillated frequency band of the input optical pulse by one octave, and the harmonic generating section 150 generates the second order harmonic of the input optical pulse. Instead, the band expanding section 130 may expand the oscillated frequency band of the input optical pulse by one or more octaves, and the harmonic generating section 150 may generate the third order or higher harmonic of the input optical pulse. In this case as well, the pulse laser 100 may detect the beat signals generated by the portions where the frequency range of the expanded band overlaps with the frequency range of the harmonic component to measure the carrier envelope offset frequency.

In the embodiments described above, the light transmitting section 140 focuses the optical pulses in the detecting section 170. Instead, the pulse laser 100 may include a second light transmitting section between the harmonic generating section 150 and the detecting section 170, and the optical pulses of the octave optical comb and the second order harmonic may be focused on the light receiving surface of the detecting section 170 at approximately the same timing. As a result, the pulse laser 100 can allow an increased degree of design freedom for the light focusing.

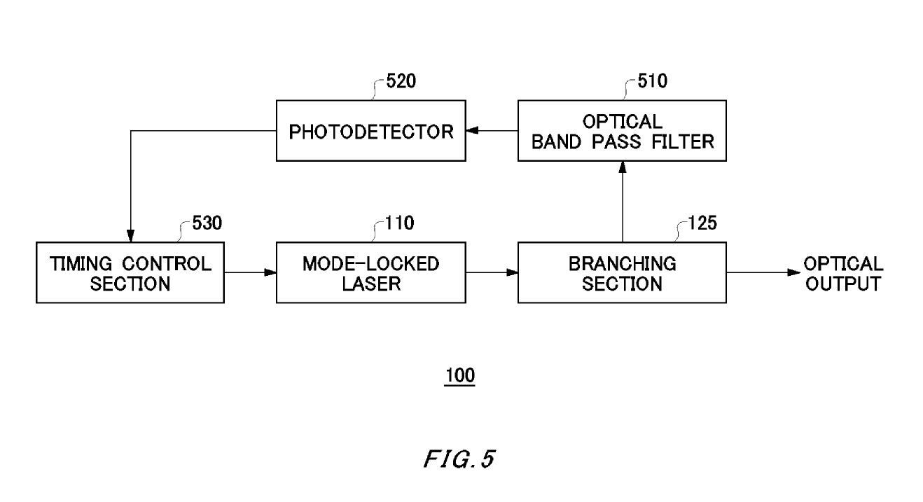

FIG. 5 shows an exemplary modification of the pulse laser 100 according to the present embodiment. Operations of the pulse laser 100 of the present modification that are the same as those of the pulse laser 100 according to the embodiment described in FIG. 1 are given the same reference numerals, and the following describes only differing points. The pulse laser 100 includes the mode-locked laser 110, the branching section 125, an optical band pass filter 510, a photodetector 520, and a timing control section 530. The pulse laser 100 determines and adjusts the optical pulse output timing of the mode-locked laser 110 by detecting a frequency component in a predetermined frequency range of the mode-locked laser 110.

The optical band pass filter 510 passes the frequency component in the predetermined frequency range of the mode-locked laser 110. The optical frequency band passed by the optical band pass filter 510 may be a half-value width, which is no greater than several MHz and preferably a narrow band no greater than several hundred kHz. For example, the optical band pass filter 510 may be an etalon filter arranged to face a two-sided highly reflective filter, or may be a fiber Bragg grating functioning as an optical filter and having a grating in the optical fiber core.

The photodetector 520 receives the optical output passed by the optical band pass filter 510. The timing control section 530 controls the output timing of the optical pulse of the mode-locked laser 110, according to the optical intensity received by the photodetector 520. The timing control section 530 may adjust the repeating frequency of the mode-locked laser 110 to control the output timing of the optical pulse from the mode-locked laser 110.

When the mode-locked laser 110 changes the repeating frequency, the output timing of the optical pulse changes according to the change of the repeating frequency. Accordingly, the timing control section 530 can control the output timing of the optical pulse from the mode-locked laser 110 by controlling the repeating frequency of the mode-locked laser 110.

Instead, the timing control section 530 may adjust the carrier envelope offset frequency by adjusting the excited optical intensity of the mode-locked laser 110 in order to control the output timing of the optical pulse from the mode-locked laser 110. When the mode-locked laser 110 changes the carrier envelope offset frequency, the output timing of the optical pulse changes according to the change of the carrier envelope offset frequency.

The mode-locked laser 110 can control the carrier envelope offset frequency by adjusting the excited optical intensity in the mode-locked laser 110. Accordingly, the timing control section 530 can adjust the carrier envelope offset frequency by adjusting the excited optical intensity of the mode-locked laser 110, in order to control the output timing of the optical pulse from the mode-locked laser 110.

The pulse laser 100 of the above modification can use the optical band pass filter 510 to measure the optical intensity of one or more optical frequency components that form the optical frequency comb. For example, when the carrier envelope offset frequency of the mode-locked laser 110 is changed, the frequency position of the optical frequency comb moves in parallel, and therefore the photodetector 520 detects the change in the optical intensity that accompanies the movement of the oscillated frequency of the optical frequency component passed by the optical band pass filter 510. In other words, the photodetector 520 can detect change in the carrier envelope offset frequency of the mode-locked laser 110.

When the repeating frequency of the mode-locked laser 110 is changed, the frequency position of the optical frequency comb changes according to the repeating frequency, and therefore the photodetector 520 can detect change in the repeating frequency. When the optical frequency component being measured is the n-th component in the optical frequency comb and the repeating frequency changes by Δf, the photodetector 520 measures a frequency change of n×Δf. When detecting the change in the carrier envelope offset frequency or the repeating frequency, the photodetector 520 can detect a change in the optical intensity with a large dynamic range by narrowing the pass bandwidth of the optical band pass filter 510.

The pulse laser 100 may measure in advance and record measurement results of the photodetector 520 changing according to the changes in the carrier envelope offset frequency or the repeating frequency. The pulse laser 100 may also measure the output timing of the optical pulses, which changes according the carrier envelope offset frequency and the repeating frequency, and record the timing as measurement results. By comparing the recorded measurement results of the photodetector 520 with each other, the pulse laser 100 can identify the optical pulse output timing based on the intensity detected by the photodetector 520.

The pulse laser 100 may use a predetermined modulation signal to adjust the change applied to the carrier envelope offset frequency or the repeating frequency. The pulse laser 100 can accurately identify the optical pulse output timing by outputting phase-modulated light and detecting, with a predetermined frequency, the output of the photodetector 520 that changes according to the modulation signal.

The pulse laser 100 can adjust the pulse output timing using the timing control section 530, based on the optical pulse output timing detected by the photodetector 520. As a result, the pulse laser 100 can output the optical pulse at a preset pulse output timing, for example. Instead, the pulse laser 100 can output the optical pulse at a pulse output timing input thereto, for example.

The pulse laser 100 according to the above modification may be used as the mode-locked laser 110 according to the embodiment shown in FIG. 1. As a result, the pulse laser 100 can output, at a known timing, an optical pulse having a known repeating frequency and/or carrier envelope offset frequency.

In the pulse laser 100 of the above modification, the optical band pass filter 510 uses an etalon filter or a fiber Bragg grating filter. Instead, the pulse laser 100 may use, as the optical band pass filter 510, an etalon filter that has approximately the same FSR (free spectrum range) as the repeating frequency of the mode-locked laser 110. Since an etalon filter is a Fabry-Perot interferometer, the etalon filter has passing characteristics by which the pass band repeats with a prescribed frequency on the frequency axis, i.e. the wavelength axis, and this period is referred to as FSR.

Matching the FSR of the etalon filter and the repeating period of the mode-locked laser 110 corresponds to matching the interval between oscillated frequency components of the optical frequency comb and the period of the pass band. In other words, when one oscillated frequency component of the optical frequency comb is aligned with one pass frequency of the etalon filter, each of the other oscillated frequency components of the optical frequency comb matches one of the other pass frequencies of the etalon filter, and the photodetector 520 can therefore detect the optical signal with a high S/N ratio.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

What is claimed is:

1. A pulse laser that controls output timing of an optical pulse, comprising:
a mode-locked laser;
an optical band pass filter that passes a frequency component of the mode-locked laser in a predetermined frequency range;
a photodetector that receives optical output passed by the optical band pass filter; and
a repeating frequency control section that controls a repeating frequency of the mode-locked laser, wherein
the repeating frequency control section controls the repeating frequency to control the output timing of the optical pulse from the mode-locked laser.

2. The pulse laser according to claim 1, wherein
the repeating frequency control section controls the repeating frequency with a modulation signal, to output phase-modulated light.

3. A pulse laser that controls output timing of an optical pulse, comprising:
a mode-locked laser;
an optical band pass filter that passes a frequency component of the mode-locked laser in a predetermined frequency range;
a photodetector that receives optical output passed by the optical band pass filter; and
a carrier envelope offset frequency control section that controls a carrier envelope offset frequency of the mode-locked laser, wherein
the carrier envelope offset frequency control section controls the carrier envelope offset frequency to control the output timing of the optical pulse from the mode-locked laser.

4. The pulse laser according to claim 3, wherein
the carrier envelope offset frequency control section controls the carrier envelope offset frequency with a modulation signal, to output phase-modulated light.

5. The pulse laser according to claim 1, further comprising:
a harmonic generating section that includes a nonlinear optical crystal that has a periodic polarization inversion structure for generating a harmonic component of the mode-locked laser; and
a detecting section that receives output from the harmonic generating section, wherein
the pulse laser measures the carrier envelope offset frequency based on output from the detecting section.

6. A pulse laser that measures a carrier envelope offset frequency of an output optical pulse, comprising:
the pulse laser according to any one of claim 1;
a band expanding section that expands an oscillated frequency range of the mode-locked laser;
a harmonic generating section that generates a harmonic component of the mode-locked laser;
a light transmitting section that inputs light to the harmonic generating section without changing relative timings of a predetermined frequency component of the mode-locked laser output from the band expanding section and a frequency component that is at least double the predetermined frequency component;
a detecting section that detects a beat signal of the harmonic component and the component passed through the harmonic generating section by the mode-locked laser; and
a calculating section that calculates the carrier envelope offset frequency based on the beat signal.

7. A pulse laser that measures a carrier envelope offset frequency of an output optical pulse, comprising:
a mode-locked laser that generates an optical pulse;
a band expanding section that expands an oscillated frequency range of the mode-locked laser;
a harmonic generating section that generates a harmonic component of the mode-locked laser;
a light transmitting section that inputs light to the harmonic generating section without changing relative timings of a predetermined frequency component of the mode-locked laser output from the band expanding section and a frequency component that is at least double the predetermined frequency component;
a detecting section that detects a beat signal of the harmonic component and the component passed through the harmonic generating section by the mode-locked laser; and
a calculating section that calculates the carrier envelope offset frequency based on the beat signal.

8. The pulse laser according to claim 7, wherein
the light transmitting section uses a converging lens to focus the optical pulse output from the band expanding section and inputs the focused optical pulse to the harmonic generating section.

9. The pulse laser according to claim 8, wherein
the converging lens focuses the optical pulse output from the band expanding section in the detecting section, via the harmonic generating section.

10. The pulse laser according to claim 8, wherein
the converging lens further focuses the optical pulse output from the band expanding section in the harmonic generating section, and
the detecting section directly receives the optical pulse output from the harmonic generating section, without the optical pulse passing through optical fiber.

11. The pulse laser according to claim 7, further comprising an optical filter section that passes a frequency component, in a predetermined frequency range, of the optical pulse output from the band expanding section, and outputs the passed frequency component to the detecting section.

12. The pulse laser according to claim 7, wherein
the detecting section detects a repeating frequency of the optical pulse of the mode-locked laser along with the beat signal.

13. The pulse laser according to claim 7, further comprising:
a first electric filter section that passes a frequency component, of the beat signal detected by the detecting section, in a first frequency range corresponding to the carrier envelope offset frequency; and
a second electric filter section that passes a frequency component, of the beat signal detected by the detecting section, in a second frequency range corresponding to the repeating frequency of the optical pulse, wherein
the calculating section calculates the carrier envelope offset frequency based on the signal passed by the first electric filter section and calculates the repeating frequency based on the signal passed by the second electric filter section.

14. The pulse laser according to claim 7, wherein
the band expanding section includes highly nonlinear fiber that expands the frequency range of the optical pulse input thereto by at least one octave.

15. The pulse laser according to claim 7, wherein
the band expanding section includes photonic crystal fiber that expands the frequency range of the optical pulse input thereto by at least one octave.

16. The pulse laser according to claim 7, wherein
the harmonic generating section includes a nonlinear optical element that generates a frequency that is at least double a predetermined frequency of the optical pulse input thereto.

17. The pulse laser according to claim 7, wherein
the harmonic generating section is a wavelength converting element obtained by applying a periodic polarization inversion process to an LiNbO₃ crystal.

18. The pulse laser according to claim 7, wherein
the light transmitting section, the harmonic generating section, and the detecting section are provided on the same optical axis.

19. A measurement apparatus that measures a carrier envelope offset frequency of a mode-locked laser, the measurement apparatus comprising:
a band expanding section that expands an oscillated frequency range of the mode-locked laser;
a harmonic generating section that generates a harmonic component of the mode-locked laser;
a light transmitting section that inputs light to the harmonic generating section without changing relative timings of a predetermined frequency component of the mode-locked laser output from the band expanding section and a frequency component that is at least double the predetermined frequency component;
a detecting section that detects a beat signal of the harmonic component and the component passed through the harmonic generating section by the mode-locked laser; and
a calculating section that calculates the carrier envelope offset frequency based on the beat signal.

20. A measurement method for measuring a carrier envelope offset frequency of a mode-locked laser, the measurement method comprising:
a mode-locked laser generation step for generating an optical pulse;
a bandwidth expansion step for expanding an oscillated frequency range of the mode-locked laser;
a harmonic generation step for generating a harmonic component of the mode-locked laser;
a light transmission step for transmitting light without changing relative timings of a predetermined frequency component of the mode-locked laser output from the bandwidth expansion step and a frequency component that is at least double the predetermined frequency component;
a detection step for detecting a beat signal of the harmonic component and the component passed in the harmonic generation step by the mode-locked laser; and
a calculation step for calculating the carrier envelope offset frequency based on the beat signal.

21. An optical-frequency-stabilized laser comprising:
a mode-locked laser that generates an optical pulse;
a band expanding section that expands an oscillated frequency range of the mode-locked laser;
a harmonic generating section that generates a harmonic component of the mode-locked laser;
a light transmitting section that inputs light to the harmonic generating section without changing relative timings of a predetermined frequency component of the mode-locked laser output from the band expanding section and a frequency component that is at least double the predetermined frequency component;
a detecting section that detects a beat signal of the harmonic component and the component passed through the harmonic generating section by the mode-locked laser;
a calculating section that calculates a carrier envelope offset frequency and a repeating frequency based on the beat signal; and
a repeating frequency phase synchronizing section that matches the repeating frequency to a first reference frequency and/or a carrier envelope offset frequency phase synchronizing section that matches the carrier envelope offset frequency to a second reference frequency.
